(19) United States
(12) Patent Application Publication
(10) Pub. No.: US 2011/0080526 A1
(43) Pub. Date: Apr. 7, 2011

(54) MULTIPLE TUNER TERRESTRIAL DTV RECEIVER FOR INDOOR AND MOBILE USERS

(75) Inventor: LIN YANG, Fremont, CA (US)

(73) Assignee: LEGEND SILICON CORP., Fremont, CA (US)

(21) Appl. No.: 12/572,236

(22) Filed: Oct. 1, 2009

(51) Int. Cl. H04N 5/44; H04L 27/01

(52) U.S. Cl. 348/725; 375/233; 348/E05.096

(57) ABSTRACT

A device is provided. the device comprises A device comprising: a Frequency Domain Maximum Ratio Combining Decision Feedback Equalizer (FD-MRC-DFE), a first device down stream to the FD-MRC-DFE; a second device down stream to the FD-MRC-DFE; and a third device for averaging the outputs of the first device and the second device.

### CROSS-REFERENCE TO OTHER APPLICATIONS

The following application of common assignee herewith is related to the present application, and is herein incorporated by reference in their entireties:

U.S. patent application Ser. No. 12/512,901 with attorney docket number LSFFT-121.

### FIELD OF THE INVENTION

The present invention relates generally to an application in a digital television system, more specifically the present invention relates to a multiple tuner terrestrial DTV receiver for indoor and mobile users.

### BACKGROUND

Single carrier terrestrial digital television (DTV) systems are deployed in the countries such as China and other countries.

For in-door or mobile users, accurate channel estimation during time periods between known, received intervals is required for receiving wireless signals. In addition to the superposition diversity of multiple tuner maximum ratio combining using Minimum Mean Square Error (MMSE) decision feedback equalization (see U.S. patent application Ser. No. 12/512,901), The challenge is to desirous to provide a receiver having accurate channel estimation during time periods between known, received intervals.

### SUMMARY OF THE INVENTION

A method and device for channel estimation in an in-door receiver is provided.

A method and device for channel estimation in an in-door digital television (DTV) is provided.

A method and device for channel estimation in an in-door terrestrial (DTV) is provided.

A method and device for channel estimation in an mobile receiver is provided.

A method and device for channel estimation in an mobile digital television (DTV) is provided.

A method and device for channel estimation in an mobile terrestrial (DTV) is provided.

A method and device for channel estimation in an mobile terrestrial (DTV) in a single carrier environment comprises China's GB20600 standard

A device is provided. A device is provided. the device comprises A device comprising: a Frequency Domain Maximum Ratio Combining Decision Feedback Equalizer (FD-MRC-DFE), a first device down stream to the FD-MRC-DFE; a second device down stream to the FD-MRC-DFE; and a third device for averaging the outputs of the first device and the second device. The method for producing the device is also provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is a first example of a first receiver in accordance with some embodiments of the invention.

FIG. 1B is a second example of a first receiver in accordance with some embodiments of the invention.

FIG. 2 is a prior art standard.

FIG. 2A is a diagram of the invention.

FIG. 3 is an example of a channel estimation diagram in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to carrier recovery, symbol/timing recovery, frequency down conversion, baseband signal filter, frame synchronization, and channel estimation for the received multiple channel signals from either single or multiple antennae with multiple tuners and then using channel decoder to overcome bad data or error in a coding context. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

It will be appreciated that embodiments of the invention described herein may be comprised of one or more conventional processors and unique stored program instructions that control the one or more processors to implement, channel estimation for received multiple channel signals. The non-processor circuits may include, but are not limited to, a radio receiver, a radio transmitter, signal drivers, clock circuits, power source circuits, and user input devices. As such, these functions may be interpreted as steps of a method to equalize the received multiple channel signals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention contemplates a wireless receiver not only used in DTV systems, but also used in such wireless systems as a personal digital assistant (PDA), a mobile PC, an Internet PC, a cell phone, or any WiMax or LTE device, as well as any mobile indoor device.

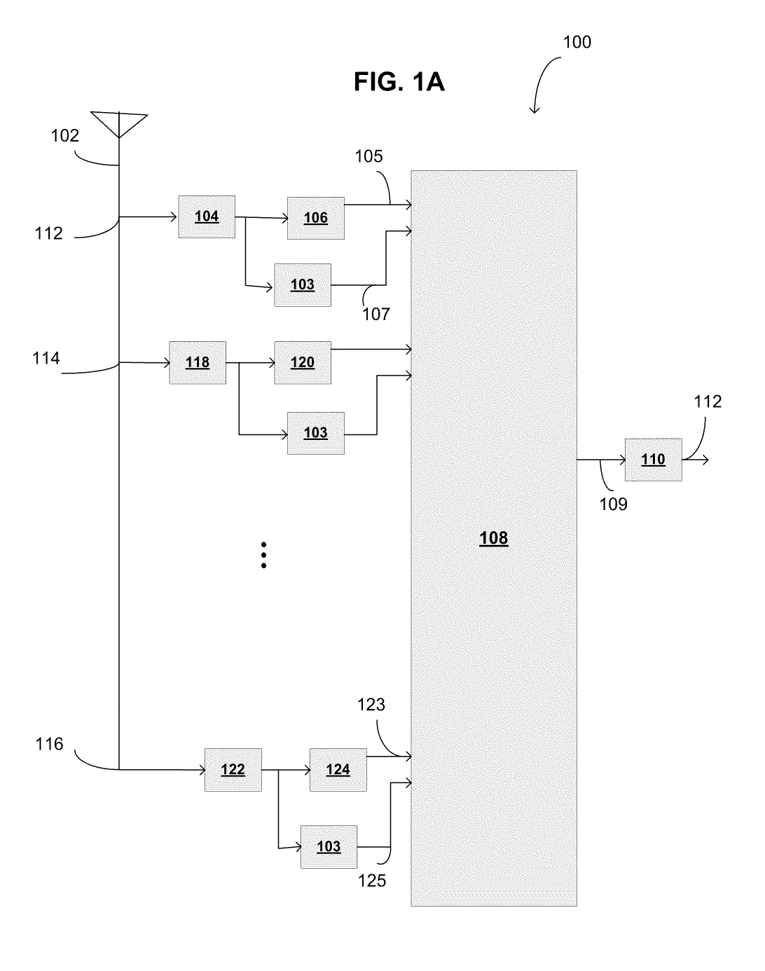

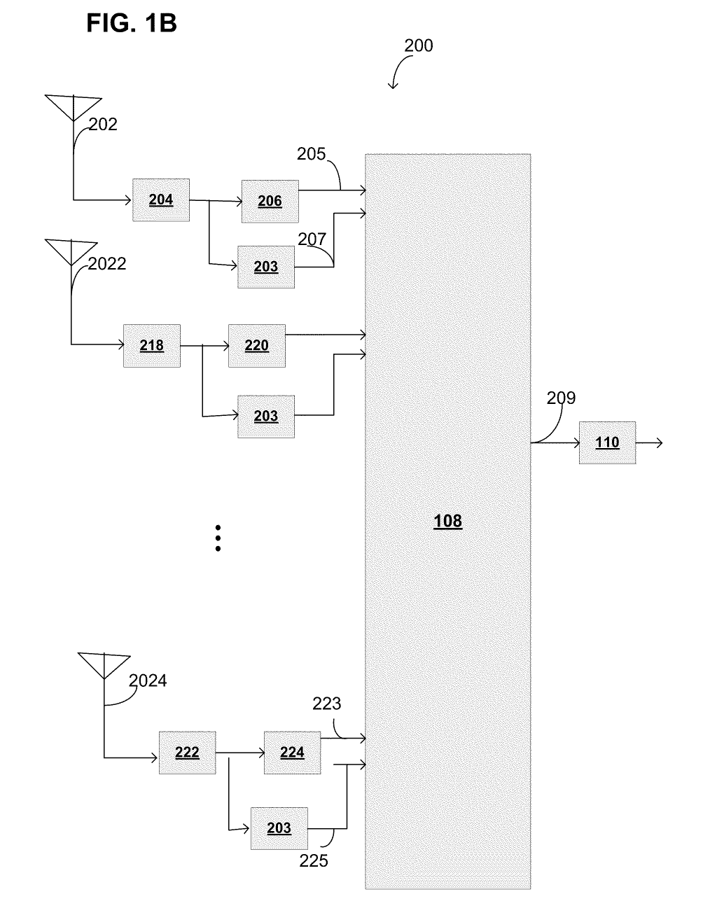

Referring to FIG. 1A, an example of a first receiver 100 in accordance with some embodiments of the invention is shown. A received signal is received by antenna 102. As can be seen, receiver 100 is a single antenna receiver such as a single antenna digital TV receiver with multiple tuners. In turn, a first tuner 104 processes the received signal r. The tuner 104 generate its proprietary signal to noise ratio based upon the tuner's noise characteristics. The received signal r, with tuner's noise characteristics, is subjected to preprocessing 106. Preprocessing comprises down conversion, carrier recovery, symbol/timing recovery, base-band signal filter, frame synchronization, and Signal to Noise Ratio (SNR). In addition to these operations, a channel estimation block 103 receives the received signal r in order to generate an output 107. After preprocessing, the respective signal 105, along with its time domain channel estimation information 107, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. This forms the first signal path 112.

Similarly, for a second signal path 114, the received signal r is received by antenna 102. In turn, a second tuner 118 processes the received signal r. The tuners 118 generate its proprietary signal to noise ratio (SNR) based upon the tuner's noise characteristics. The received signal, with its noise characteristics, is subjected to preprocessing 120. Preprocessing comprises down conversion, carrier recovery, symbol/timing recovery, base-band signal filter, frame synchronization, and Signal to Noise Ratio (SNR). In addition to these operations, a channel estimation block receives the received signal r in order to generate a channel estimation output. After preprocessing, the respective signal, along with its time domain channel estimation information, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. This forms the first signal path 112.

Therefore, generically, of the Nth path 116, the received signal is received by antenna 102. In turn, a first tuner 122 processes the received signal. The tuners 122 generate its proprietary signal to noise ratio based upon the tuner's noise characteristics. The received signal, with its noise characteristics, is subjected to preprocessing 124.

Preprocessing comprises down conversion, carrier recovery, symbol/timing recovery, base-band signal filter, frame synchronization, and Signal to Noise Ratio (SNR). In addition to these operations, a channel estimation block 123 receives the received signal r to generate an output 125. After preprocessing, the respective signal 123, along with its time domain channel estimation information 125, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. This forms the first signal path 112.

Referring to FIG. 1B, an example of a second receiver 200 in accordance with some embodiments of the invention is shown. A received signal r is received by a plurality of antennae comprising a set of N antennae (N being a natural number, with N greater than or equal to 2). Each antenna has its own tuner. Each antenna and an associated tuner form a signal path.

A first tuner 204 processes the received signal r. The tuners 204 generate its proprietary signal to noise ratio based upon the tuner's noise characteristics. The received signal, with its noise characteristics, is subjected to preprocessing 206.

Preprocessing comprises down conversion, carrier recovery, symbol/timing recovery, base-band signal filter, frame synchronization, and Signal to Noise Ratio (SNR). In addition to these operations, a channel estimation block 203 receives the received signal r in order to generate an output 207. After preprocessing, the respective signal 205, along with its time domain channel estimation information 207, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. This forms the first signal path 112.

Similarly, for a second signal path 2022, the received signal is received by antenna 2022. In turn, a second tuner 218 processes the received signal. The tuners 218 generate its proprietary signal to noise ratio based upon the tuner's noise characteristics. The received signal, with its noise characteristics, is subjected to preprocessing 220.

Preprocessing comprises down conversion, carrier recovery, symbol/timing recovery, base-band signal filter, frame synchronization, and Signal to Noise Ratio (SNR). In addition to these operations, a channel estimation block 203 receives the received signal r in order to generate an output. After preprocessing, the respective signal, along with its time domain channel estimation information, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. This forms the first signal path 112.

This forms the second signal path 212. Note that only three paths are shown. However, in practice, up to N (N being a natural number, with N greater than or equal to 2) paths may be formed.

Therefore, generically, of the Nth path 2024, the received signal r is received by antenna 2024. In turn, a Nth tuner 222 processes the received signal. The tuner 222 generate its proprietary signal to noise ratio based upon the tuner's noise characteristics. The received signal, with its noise characteristics, is subjected to preprocessing 224. Preprocessing comprises down conversion, carrier recovery, symbol/timing recovery, base-band signal filter, frame synchronization, and Signal to Noise Ratio (SNR). In addition to these operations, a channel estimation block 103 receives the received signal r in order to generate an output 207. After preprocessing, the respective signal 205, along with its time domain channel estimation information 207, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc.

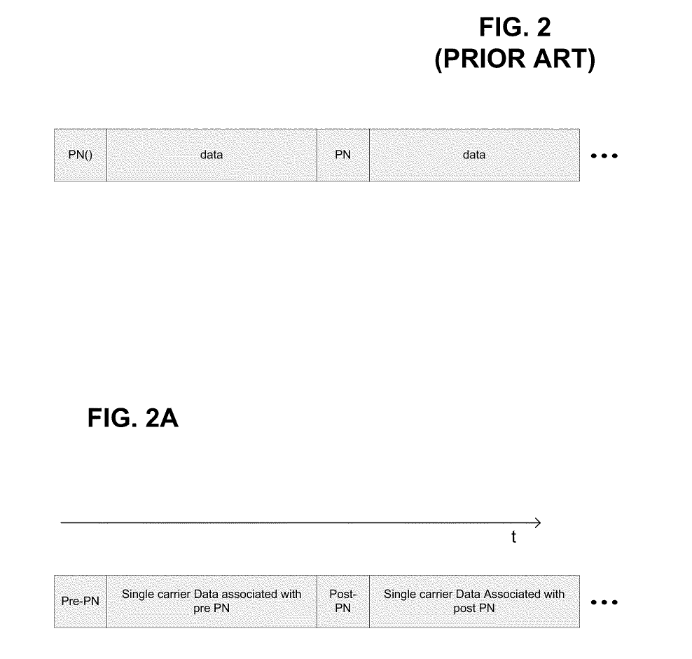

Referring to FIG. 2, a known prior art diagram is shown. Note the pseudo noise (PN) synchronization signals disposed between content data.

Referring to FIG. 2A, a known a diagram of the invention is shown. Note the pseudo noise (PN) synchronization signals disposed between content data comprise pre-PN and post-PN. The present invention addresses channel estimation between these gaps.

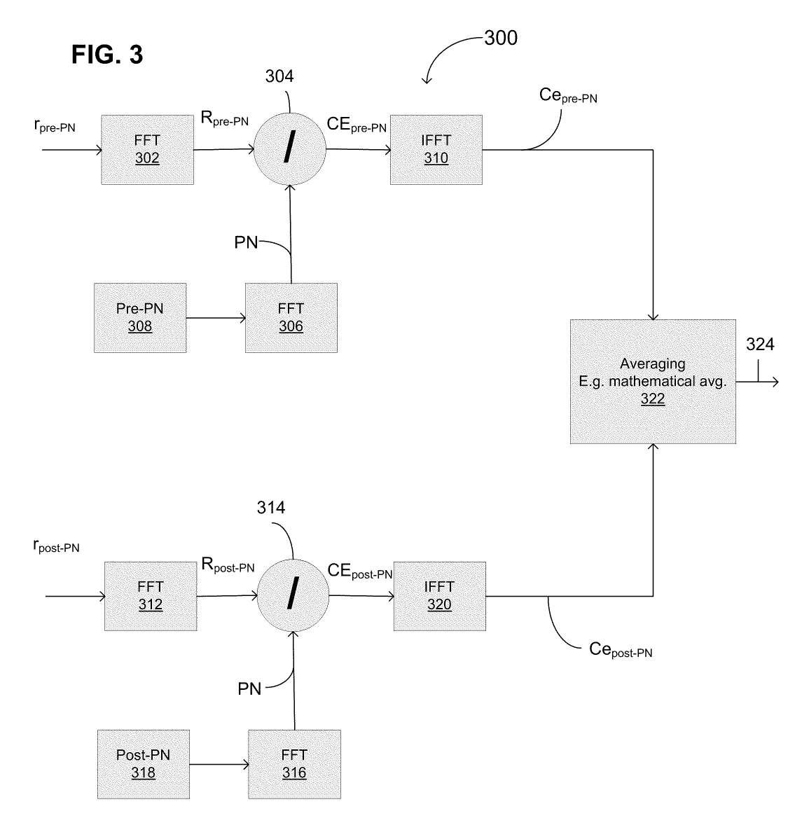

Referring to FIG. 3, an example of channel estimation 300 is shown. For a first path, a received signal rᵢ associated with a pre-PN is input into a first Fourier transformers (FFT) 302. The transformed, frequency domain signal Rᵢ is subjected to a first divider 304. Divider 304 has another input PN which is the transformed results of inputs subjected to a second fast Fourier transformers (FFT) 306. The input for second fast Fourier transformers (FFT) 306 is a time domain local pre-PN signal 308. In turn, the quotient of divider 304 is input into a first Inverse fast Fourier transformer 310 to transform back to the time domain. The transformed signal is the channel estimation ce_{pre-PN} associated with pre-PN.

For a first path, a received signal r, associated with a post-PN is input into a third Fourier transformers (FFT) 312. The transformed, frequency domain signal Rᵢ is subjected to a second divider 314. Divider 314 has another input PN which is the transformed results of inputs subjected to a third fast Fourier transformers (FFT) 316. The input for fourth fast Fourier transformers (FFT) 316 is a time domain local post-PN signal 318. In turn, the quotient of divider 314 is input into a second Inverse fast Fourier transformer (IFFT) 320 to transform back to the time domain. The transformed signal is the channel estimation ce_{post-PN} associated with post-PN.

As can be seen, the output of the first inverse fast Fourier transformer (IFFT) 310 and the second Inverse fast Fourier transformer (IFFT) 320 are respectively the channel estimation ce_{pre-PN} associated with pre-PN and the channel estimation ce_{post-PN}. Both are input into averaging block 322 for an averaging process. The resultant output 324 is the averaged channel estimation of the present invention. The averaging may be a simple mathematical averaging.

It is noted that for in-door receivers, due to dynamic multipath resulting from living object (e.g. human) movement inside a man made or otherwise enclosure, channel estimation within the time gap between standard or known channel estimation is required.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A device comprising:
a Frequency Domain Maximum Ratio Combining Decision Feedback Equalizer (FD-MRC-DFE),
a first device down stream to the FD-MRC-DFE;
a second device down stream to the FD-MRC-DFE; and
a third device for averaging the outputs of the first device and the second device.

2. The device of claim 1 is associated with a single antenna being coupled to a plurality of tuners having the FD-MRC-DFE block.

3. The device of claim 1 is associated with a plurality of antennae being coupled to a plurality of tuners having the FD-MRC-DFE block.

4. The device of claim 1, wherein the single carrier environment comprises China's GB20600 standard.

5. The device of claim 1, wherein the device is used in a DTV receiver.

6. The device of claim 1, wherein the device is used in a mobile wireless receiver.

7. A method comprising:
providing a Frequency Domain Maximum Ratio Combining Decision Feedback Equalizer (FD-MRC-DFE),
providing a first device down stream to the FD-MRC-DFE;
providing a second device upstream to the FD-MRC-DFE; and
providing a third device for averaging the outputs of the first device and the second device.

8. The method of claim 7 is associated with a single antenna being coupled to a plurality of tuners having the FD-MRC-DFE block.

9. The method of claim 7 is associated with a plurality of antennae being coupled to a plurality of tuners having the FD-MRC-DFE block.

10. The method of claim 7, wherein the single carrier environment comprises China's GB20600 standard.

11. The method of claim 7, wherein the device is used in a DTV receiver.

16. The method of claim 7, wherein the device is used in a mobile wireless receiver.
